(19) United States
(12) Patent Application Publication
(10) Pub. No.: US 2023/0256487 A1
(43) Pub. Date: Aug. 17, 2023

(54) SYSTEM FOR ACCELERATING SALT LEACHING AND DRAINAGE OF SOIL BASED ON NEGATIVE PRESSURE

(71) Applicant: Jiangsu University, Jiangsu (CN)

(72) Inventors: Chuan ZHANG, Jiangsu (CN); Junan ZHOU, Jiangsu (CN); Haofang YAN, Jiangsu (CN); Wencheng ZHANG, Jiangsu (CN); Yuxin NI, Jiangsu (CN)

(73) Assignee: Jiangsu University, Jiangsu (CN)

(21) Appl. No.: 17/911,139

(22) PCT Filed: Feb. 25, 2022
(86) PCT No.: PCT/CN2022/077955

§ 371 Date: Sep. 13, 2022

(30) Foreign Application Priority Data
Sep. 27, 2021 (CN) 202111135270.X

(51) Int. Cl. B09C 1/02; E02B 11/00

(52) U.S. Cl. CPC B09C 1/02; E02B 11/005; B09C 2101/00

(57) ABSTRACT

The present disclosure provides a system for accelerating salt leaching and drainage of soil based on a negative pressure, and relates to the technical field of soil improvement. The system includes a concealed pipe. The concealed pipe is communicated with a negative pressure chamber. The negative pressure chamber is communicated with an air extracting pump through an air extraction port, and the air extracting pump is configured to evacuate the negative pressure chamber. In the present disclosure, the concealed pipe is arranged, the structure of the concealed pipe is improved, and the negative pressure chamber is arranged between the air extracting pump and the concealed pipe. By evacuating the negative pressure chamber to form a negative pressure area around the concealed pipe for field drainage, the drainage of water in soil is accelerated by the pressure difference, thereby improving the efficiency of drainage and salt leaching per unit time.

### TECHNICAL FIELD

The present disclosure relates to the technical field of soil improvement, and more particularly to a system for accelerating salt leaching and drainage of soil based on a negative pressure.

### RELATED ART

Land salinization is one of the common soil degradation problems. Nearly one-fifth of the cultivated land in China is salinized, resulting in a serious waste of land resources. At present, China's “14th Five-Year Plan” proposes to focus on the primary grain production zone and the protected production zone of major agricultural products and to build 100 million mu (about 6.7 million hectares) of high-standard farmland by 2021. High-standard farmland refers to fertile land with high and stable yield that is leveled, concentrated and contiguous, with complete facilities, farmland supporting facilities, soil, good ecology, strong resistance to disasters such as drought and flood, and suitable for modern agricultural production and management modes. Therefore, there is an urgent need to address the problem of land salinization in order to meet the needs of high-standard farmland.

At present, a commonly used method is to remove salts by using a large amount of water. Specifically, through rainfall or by pouring a large amount of water into the farmland, the salts in the soil dissolve in the water and flow into the drainage ditch or concealed drainage pipes, so as to reduce the salts in the soil. However, due to the physical properties of the soil, after the soil is saturated with water, the moving speed of water in the soil decreases, and therefore, the efficiency of drainage of water in soil decreases, resulting in an increase in the time required for the drainage of water in soil.

### SUMMARY OF INVENTION

In view of the problems in the prior art, the present disclosure provides a system for accelerating salt leaching and drainage of soil based on a negative pressure. In this system, a concealed pipe is arranged, the structure of the concealed pipe is improved, and a negative pressure chamber is arranged between an air extracting pump and the concealed pipe. By evacuating the negative pressure chamber to form a negative pressure area around the concealed pipe for drainage, the flowing of water in soil into the negative pressure chamber through the concealed pipe is accelerated by the pressure difference. Salinity analysis is carried out for the water in the negative pressure chamber. The water in the negative pressure chamber is treated based on the result of the salinity analysis. The above technical object of the present disclosure is achieved through the following technical means.

A system for accelerating salt leaching and drainage of soil based on a negative pressure is provided, including a concealed pipe. The concealed pipe is communicated with a negative pressure chamber. The negative pressure chamber is communicated with an air extracting pump through an air extraction port, and the air extracting pump is configured to evacuate the negative pressure chamber.

Further, the concealed pipe is a hollow pipe, a plurality of water inlet holes are provided on an outer wall of the concealed pipe, a water-permeable structure is sheathed in an inner side wall of the concealed pipe, and openings are respectively formed on two ends of the water-permeable structure; the water-permeable structure includes an arc-shaped structure and a water-permeable plate, where the arc-shaped structure is fitted with the inner side wall of the concealed pipe, and a plurality of water suction ports are provided on the water-permeable plate; a liquid flows into the concealed pipe through the water inlet holes, enters the water-permeable structure through the water suction ports, and then flows into the negative pressure chamber through the openings of the water-permeable structure.

Further, the concealed pipe is a hollow cylindrical pipe, a water-permeable plate is arranged in the concealed pipe, and the water-permeable plate divides the concealed pipe into an upper-layer concealed pipe and a lower-layer concealed pipe, where a plurality of water inlet holes are provided on an outer side wall of the upper-layer concealed pipe, and a plurality of water suction ports are provided on the water-permeable plate; a liquid flows into the upper-layer concealed pipe through the water inlet holes and then flows out of the upper-layer concealed pipe through the water suction ports and flows into the negative pressure chamber.

Further, the water suction ports are each of an inverted truncated cone structure.

Further, a height of the water-permeable structure or a height of the lower-layer concealed pipe is 0 to ¼ of a height of the concealed pipe.

Further, two ends of the concealed pipe are sealed except for the two ends of the water-permeable structure or two ends of the lower-layer concealed pipe.

Further, the air extracting pump is mobile and is configured to be used in different areas.

Further, the negative pressure chamber is arranged under soil, and a liquid level sensor and a pressure gauge are arranged on the negative pressure chamber, where the liquid level sensor is configured to monitor and feedback a liquid level of the negative pressure chamber, and the pressure gauge is configured to display a value of a pressure in the negative pressure chamber.

Further, the negative pressure chamber is provided with a water collecting port, and the water collecting port is communicated with the concealed pipe through a flange.

Further, the negative pressure chamber is provided with a water pumping port, and a liquid in the negative pressure chamber is discharged through a submersible pump.

Further, an air extraction pipe is arranged on the air extracting pump, and the air extraction pipe is communicated with the air extraction port provided on the negative pressure chamber; and a one-way valve is arranged on the air extraction pipe.

### Beneficial Effects

1. In the system, the air extracting pump does not directly act on soil, but acts on the negative pressure chamber, to overcome the difficulty in evacuating the soil that contains both gas and liquid phases. With the arrangement of the negative pressure chamber in the system and by evacuating the negative pressure chamber, water in the soil is quickly drained through the pressure difference between the inside and outside of the concealed pipe for drainage, so as to improve the water drainage efficiency.

2. In the system, the structural design of an existing concealed pipe is improved by changing a conventional single-layer concealed pipe to a concealed pipe having an upper layer and a lower layer. The left and right ends of the upper layer are sealed, and one end of the lower layer is connected into the negative pressure chamber. Such a structural configuration facilitates the formation of a negative pressure area in the lower layer, thereby improving the evacuating efficiency.

3. The upper layer and lower layer of the concealed pipe are separated by the water-permeable plate. The formation of the holes in the shape of an inverted truncated cone having a larger upper end and a smaller lower end on the water-permeable plate facilitates the formation of a water film on the water-permeable plate, providing a better sealing effect for the lower layer of the concealed pipe.

4. An air pressure sensor is arranged on the negative pressure chamber. Two thresholds, threshold 1 and threshold 2, are set for the air pressure sensor. The setting of the threshold 2 depends on the performance characteristic curve of the pump. The threshold 2 is set to be slightly higher than an optimal operating point of the pump, while ensuring that the optimal operating point meets the negative pressure requirement. The threshold 1 is set to be slightly lower than the optimal operating point of the pump. When the air pressure in the negative pressure chamber reaches the threshold 2, the air extracting pump is turned off. At this moment, due to the presence of the pressure difference, the water in the soil still flows into the concealed pipe at an increased speed. The arrangement of the one-way valve in the air extraction pipe prevents the air from flowing back during evacuating. Because the air extracting pump is turned off, the air pressure in the negative pressure chamber gradually increases, and the evacuating capacity for the water in the soil is weakened. When the air pressure in the negative pressure chamber reaches the threshold 1, the air extracting pump is turned on for evacuating. In this way, evacuating is repeatedly performed, so as to achieve the effect of accelerating salt leaching and drainage of soil.

### BRIEF DESCRIPTION OF DRAWINGS

FIG. 1 is a schematic layout view of a system in a field.

FIG. 2 is a three-dimensional structural diagram of a concealed pipe.

FIG. 3 is a structural cross-sectional view of the concealed pipe.

FIG. 4 is a schematic view of water suction ports on a water-permeable plate in the concealed pipe.

FIG. 5 is a schematic enlarged view of a water suction port.

FIG. 6 is a schematic view of a mobile air extracting pump.

FIG. 7 is a schematic view of an air extraction pipe connected with a negative pressure chamber.

FIG. 8 is a front view of the negative pressure chamber.

FIG. 9 is a top view of the negative pressure chamber.

FIG. 10 is an operational flowchart.

FIG. 11 is a principle view of drainage of water through the concealed pipe without evacuating.

FIG. 12 is a principle view of drainage of water through the concealed pipe while evacuating.

### REFERENCE NUMERALS

1—cultivated land, 2—concealed pipe, 3—air extracting pump, 4—field path, 5—negative pressure chamber, 21—water inlet hole, 22—upper-layer concealed pipe, 23—lower-layer concealed pipe, 24—water-permeable plate, 25—water suction port, 31—air extraction pipe, 32—air extracting pump, 33—exhaust pipe, 40—countersunk base, 41—boss through hole, 42—air extraction pipe fitting hole, 51—water pumping port, 52—pressure gauge, 53—boss, 54—water collecting port, 55—submersible pump, 56—liquid level sensor, 57—rivet, 58—air extraction port.

### DESCRIPTION OF EMBODIMENTS

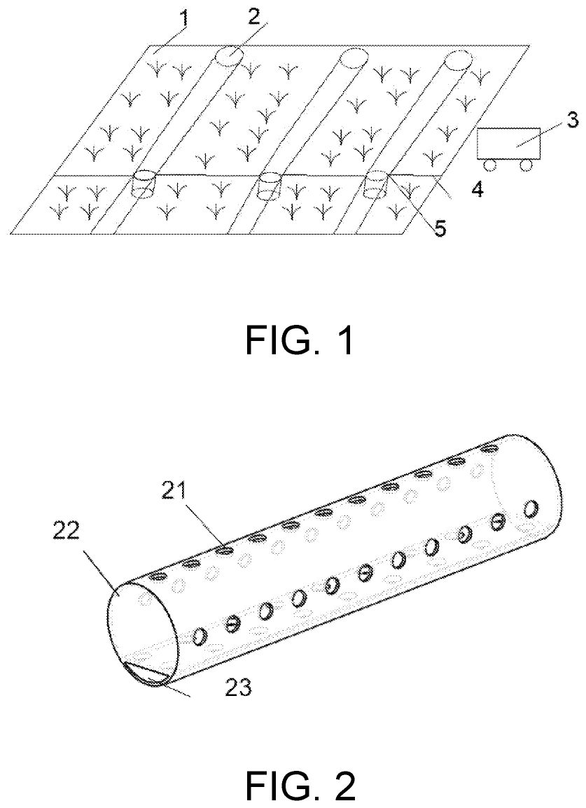

Referring to FIG. 1, cultivated land 1 receives rainfall or is exposed to flooding irrigation. Salts in the soil dissolve into the infiltrated water. The salt-containing water flows into a negative pressure chamber 5 through a concealed pipe 2 under gravity. A mobile air extracting pump 3 is connected to an air extraction port 58 for evacuating, so as to accelerate the drainage of water through the concealed pipe.

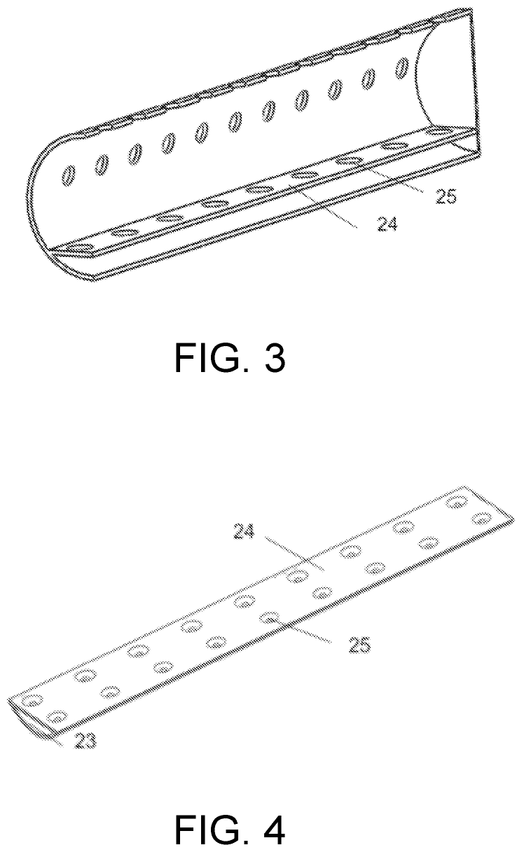

Referring to FIG. 2, FIG. 3, and FIG. 4, a plurality of water inlet holes 21 are provided on the upper-layer concealed pipe for the inflow of soil water. Half of the circular structure of the concealed pipe is provided with holes. Specifically, the upper-layer concealed pipe is provided with the water inlet holes 21, and the lower-layer concealed pipe 23 is a closed space. A water-permeable plate 24 arranged in the middle of the concealed pipe can support the concealed pipe, which can not only increase the pressure in the pipe, but also form a sealed space in the lower part of the pipe. Because only the upper part of the concealed pipe is provided with holes, no secondary leakage will occur. When water flows into the upper-layer concealed pipe, the water flows into the lower-layer concealed pipe, a negative pressure area is formed to accelerate the drainage. The water flowing into the concealed pipe flows from the upper-layer concealed pipe 22 to the lower-layer concealed pipe 23 through water suction ports 25 on the water-permeable plate 24. At this time, because the water keeps flowing through the water suction ports 25, it is difficult for air to enter the lower water outlet, and a sealed space is formed in the lower-layer concealed pipe 23. When the negative pressure chamber 5 is evacuated, the water flowing into the upper-layer concealed pipe 22 flows into the lower-layer concealed pipe 23 and finally flows into the negative pressure chamber under the joint action of both gravity and suction at an increased speed.

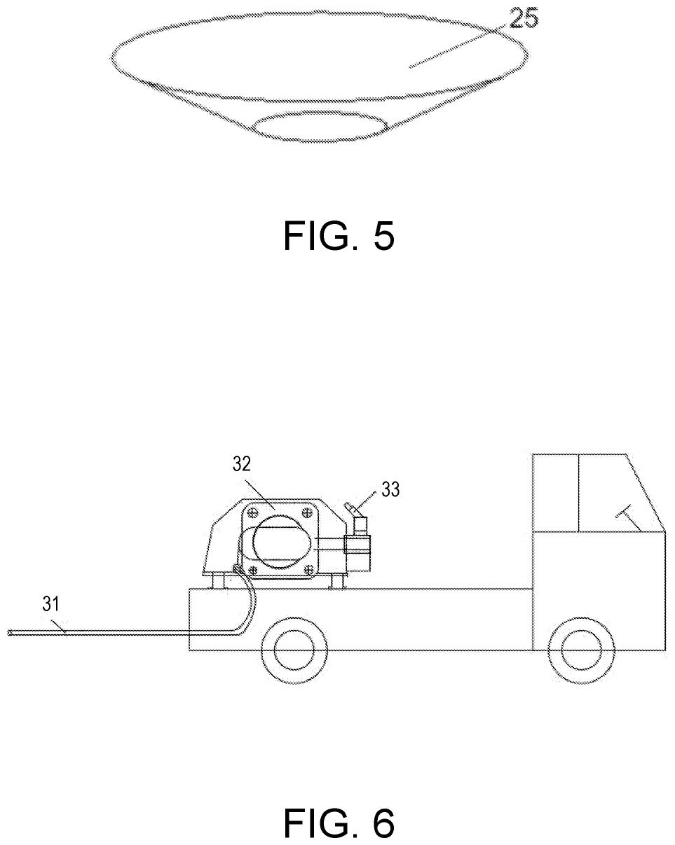

Referring to FIG. 5, the water suction ports 25 are each of an inverted truncated cone structure having a larger upper end and a smaller lower end. A height of the lower-layer concealed pipe 23 accounts for about ¼ of a height of the concealed pipe. The advantage of such a design lies in that a negative pressure area is easily formed in the concealed pipe. Compared with the method where the soil is evacuated directly with an air extracting pump, but it is difficult to form a negative pressure area in the soil containing both gas and liquid phases, the advantage of the system lies in that the water in the soil can be sucked into the negative pressure chamber as much as possible. Because it is difficult to form a negative pressure area in the soil containing both gas and liquid phases by directly evacuating the soil, in this system, negative pressure is first formed in the negative pressure chamber by using the air extracting pump. Because the concealed pipe is connected with the negative pressure chamber, a negative pressure area is formed in the concealed pipe, so that the salt-containing water in the soil can be discharged quickly.

Referring to FIG. 6, the air extracting pump 3 is connected to the negative pressure chamber 5 through an air extraction pipe 31, to suck air and discharge the air through an exhaust pipe 33. The air extracting pump 3 is mobile, and can perform evacuating in each field with a negative pressure chamber, thereby reducing the costs.

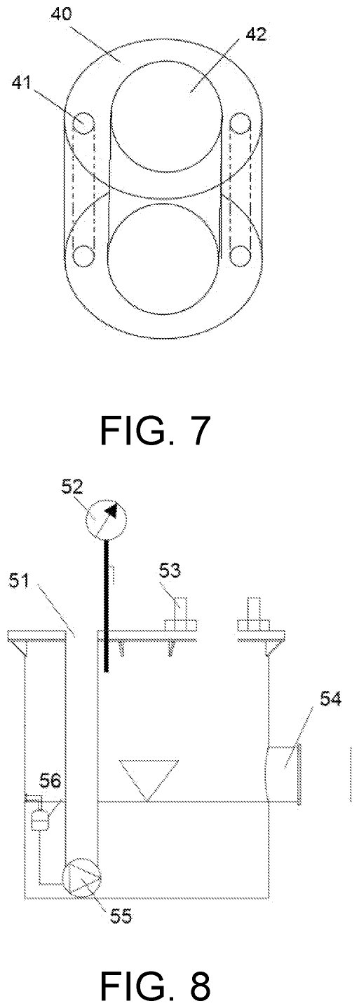

Referring to FIG. 7, the air extraction pipe 31 is welded to a countersunk base 40 through an air extraction pipe fitting hole 42, and a boss through hole 41 is connected to a boss 53 to ensure that the air extraction pipe 31 can be firmly connected to the negative pressure chamber 5.

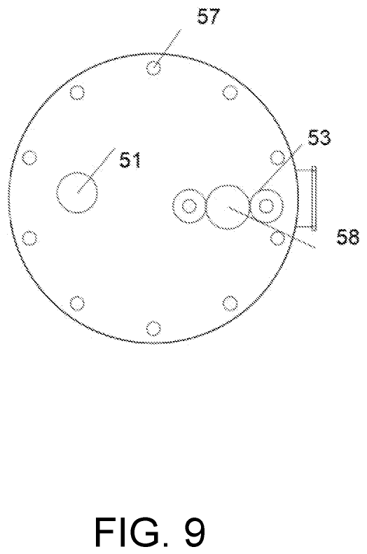

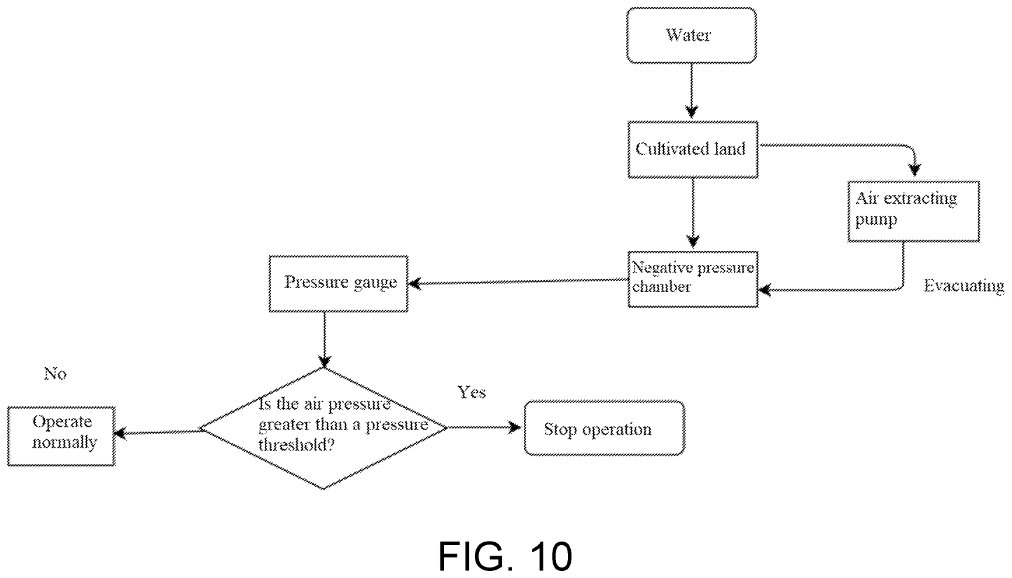

Referring to FIG. 8 and FIG. 9, the negative pressure chamber 5 is buried underground, and a top end of the negative pressure chamber is even with ground. The concealed pipe may be connected, installed, and replaced through a flange. The salt-containing water flows into the negative pressure chamber through the water collecting port 54. A liquid level sensor 56 is installed in the negative pressure chamber 5 to control a submersible pump 55. When a set liquid level is reached, the water can be drained through a water pumping port 51. A pressure gauge 52 is arranged to detect the negative pressure in the negative pressure chamber 5. When no evacuating is performed, the pressure in the negative pressure chamber 5 is equal to the atmospheric pressure, i.e., 0.1 Mpa. When the air extracting pump 32 is turned on, two thresholds, threshold 1 and threshold 2, are set for the pressure gauge 52. The setting of the threshold 2 depends on the performance characteristic curve of the pump. The threshold 2 is set to be slightly higher than an optimal operating point of the pump, while ensuring that the optimal operating point meets the negative pressure requirement. The threshold 1 is set to be slightly lower than the optimal operating point of the pump. When the air pressure in the negative pressure chamber 5 reaches the threshold 2, the air extracting pump 32 is turned off. At this moment, the water in the soil still flows into the negative pressure chamber 5 through the concealed pipe at an increased speed. When the air extracting pump is turned off, the negative pressure in the negative pressure chamber 5 gradually decreases, and the rate of drainage of water from the soil begins to decrease. When the air pressure in the negative pressure chamber 5 reaches the threshold 1, the air extracting pump 32 is turned on for evacuating. In this way, the negative pressure chamber is repeatedly evacuated to achieve the effect of accelerating salt leaching and drainage of soil. In the present disclosure, the arrangement of the air pressure sensor and the one-way valve enables the air extracting pump to always work at the optimal point, thereby improving the efficiency of salt leaching of soil.

Theoretical basis: Flowing direction of water: Soil water potential: high→low

Soil water potential: Ψₜ=Ψₘ+Ψₛ+Ψ_{g}+Ψₚ. For a certain soil texture and buried depth of the concealed pipe (reference zero plane), the matrix potential Ψₘ, the solute potential Ψₛ, and the gravitational potential Ψ_{g} remain unchanged, and the pressure potential Ψₚ of the soil water can be changed by the negative pressure generated in the concealed pipe.

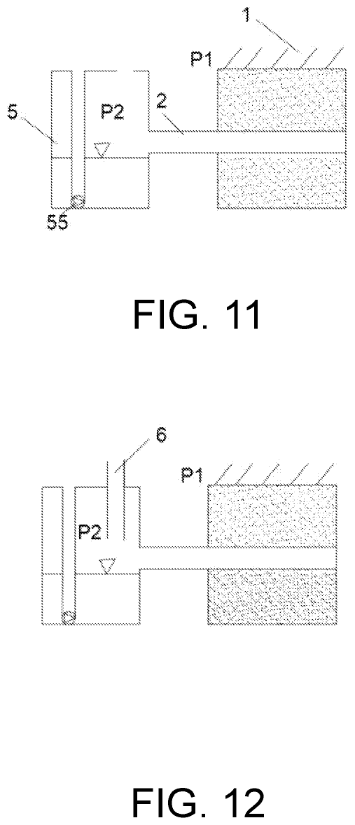

When cultivated land receives rainfall or irrigation, soil water will go through two stages: one is unsaturated flow, and the other is saturated flow. The saturated flow can be expressed by Darcy's law: q=−k×(dh/dx), where dh/dx represents the hydraulic gradient, k represents the saturated hydraulic conductivity which is affected by soil factors, and − represents the flowing direction of water. Referring to FIG. 11, before the system is evacuated, the concealed pipe 2 is connected to the atmosphere through the negative pressure chamber 5. In this case, the air pressure P2 in the concealed pipe is equal to the atmospheric pressure P1, and the total potential of soil water is mainly gravitational potential (Ψ_{g}=ρgh). After the system is evacuated, the air pressure P2 in the concealed pipe decreases. In this case, the total potential of soil water (Ψₜ=P1−P2+ρgh) increases, and the hydraulic gradient increases, i.e., the amount of soil water discharged per unit time increases.

In the description of the specification, the description with reference to the terms “an embodiment”, “some embodiments”, “example”, “specific example”, or “some example” and so on means that specific features, structures, materials or characteristics described in connection with the embodiment or example are embraced in at least one embodiment or example of the present disclosure. In the present specification, the illustrative expression of the above terms is not necessarily referring to the same embodiment or example. Moreover, the described specific features, structures, materials or characteristics may be combined in any suitable manner in one or more embodiments.

Although the embodiments of the present disclosure have been illustrated and described above, it is to be understood that the above embodiments are exemplary and not to be construed as limiting the present disclosure, and that changes, modifications, substitutions and alterations can be made by those skilled in the art without departing from the scope of the present disclosure.

1. A system for accelerating salt leaching and drainage of soil based on a negative pressure, comprising a concealed pipe, wherein the concealed pipe is communicated with a negative pressure chamber; the negative pressure chamber is communicated with an air extracting pump through an air extraction port, and the air extracting pump is configured to evacuate the negative pressure chamber, and wherein
the concealed pipe is a hollow pipe, a plurality of water inlet holes are provided on an outer wall of the concealed pipe, a water-permeable structure is sheathed in an inner side wall of the concealed pipe, and openings are respectively formed on two ends of the water-permeable structure; the water-permeable structure comprises an arc-shaped structure and a water-permeable plate, wherein the arc-shaped structure is fitted with the inner side wall of the concealed pipe, and a plurality of water suction ports are provided on the water-permeable plate; a liquid flows into the concealed pipe through the water inlet holes, enters the water-permeable structure through the water suction ports, and then flows into the negative pressure chamber through the openings of the water-permeable structure.

2. (canceled)

3. A system for accelerating salt leaching and drainage of soil based on a negative pressure comprising a concealed pipe, wherein the concealed pipe is communicated with a negative pressure chamber; the negative pressure chamber is communicated with an air extracting pump through an air extraction port, and the air extracting pump is configured to evacuate the negative pressure chamber, and wherein the concealed pipe is a hollow cylindrical pipe, a water-permeable plate is arranged in the concealed pipe, and the water-permeable plate divides the concealed pipe into an upper-layer concealed pipe and a lower-layer concealed pipe, wherein a plurality of water inlet holes are provided on an outer side wall of the upper-layer concealed pipe, and a plurality of water suction ports are provided on the water-permeable plate; a liquid flows into the upper-layer concealed pipe through the water inlet holes and then flows out of the upper-layer concealed pipe through the water suction ports and flows into the negative pressure chamber.

4. The system for accelerating the salt leaching and drainage of the soil based on the negative pressure according to claim 1, wherein the water suction ports are each of an inverted truncated cone structure.

5. The system for accelerating the salt leaching and drainage of the soil based on the negative pressure according to claim 1, wherein a height of the water-permeable structure is 0 to ¼ of a height of the concealed pipe.

6. The system for accelerating the salt leaching and drainage of the soil based on the negative pressure according to claim 1, wherein two ends of the concealed pipe are sealed except for the two ends of the water-permeable structure.

7. The system for accelerating the salt leaching and drainage of the soil based on the negative pressure according to claim 1, wherein the air extracting pump is a mobile air extracting pump.

8. The system for accelerating the salt leaching and drainage of the soil based on the negative pressure according to claim 1, wherein the negative pressure chamber is arranged under soil, and a liquid level sensor and a pressure gauge are arranged on the negative pressure chamber, wherein the liquid level sensor is configured to monitor and feedback a liquid level of the negative pressure chamber, and the pressure gauge is configured to display a value of a pressure in the negative pressure chamber.

9. The system for accelerating the salt leaching and drainage of the soil based on the negative pressure according to claim 1, wherein the negative pressure chamber is provided with a water collecting port, the water collecting port is communicated with the concealed pipe through a flange, and a liquid in the negative pressure chamber is discharged through a water pumping port.

10. The system for accelerating the salt leaching and drainage of the soil based on the negative pressure according to claim 1, wherein an air extraction pipe is arranged on the air extracting pump, and the air extraction pipe is communicated with the air extraction port provided on the negative pressure chamber; and a one-way valve is arranged on the air extraction pipe.

11. The system for accelerating the salt leaching and drainage of the soil based on the negative pressure according to claim 3, wherein the water suction ports are each of an inverted truncated cone structure.

12. The system for accelerating the salt leaching and drainage of the soil based on the negative pressure according to claim 3, wherein a height of the lower-layer concealed pipe is 0 to ¼ of a height of the concealed pipe.

13. The system for accelerating the salt leaching and drainage of the soil based on the negative pressure according to claim 3, wherein two ends of the concealed pipe are sealed except for two ends of the lower-layer concealed pipe.

14. The system for accelerating the salt leaching and drainage of the soil based on the negative pressure according to claim 3, wherein the air extracting pump is a mobile air extracting pump.

15. The system for accelerating the salt leaching and drainage of the soil based on the negative pressure according to claim 3, wherein the negative pressure chamber is arranged under soil, and a liquid level sensor and a pressure gauge are arranged on the negative pressure chamber, wherein the liquid level sensor is configured to monitor and feedback a liquid level of the negative pressure chamber, and the pressure gauge is configured to display a value of a pressure in the negative pressure chamber.

16. The system for accelerating the salt leaching and drainage of the soil based on the negative pressure according to claim 3, wherein the negative pressure chamber is provided with a water collecting port, the water collecting port is communicated with the concealed pipe through a flange, and a liquid in the negative pressure chamber is discharged through a water pumping port.

17. The system for accelerating the salt leaching and drainage of the soil based on the negative pressure according to claim 3, wherein an air extraction pipe is arranged on the air extracting pump, and the air extraction pipe is communicated with the air extraction port provided on the negative pressure chamber; and a one-way valve is arranged on the air extraction pipe.
